(19) United States
(12) Patent Application Publication
(10) Pub. No.: US 2026/0246917 A1
(43) Pub. Date: Aug. 20, 2026

(54) ELECTRONIC DEVICE AND SCREEN DISPLAY METHOD

(71) Applicant: Samsung Electronics Co., Ltd., Suwon-si (KR)

(72) Inventors: Hoon HAN, Suwon-si (KR); Changmo YANG, Suwon-si (KR); Jaewan CHOI, Suwon-si (KR); Hyejee CHOI, Suwon-si (KR)

(21) Appl. No.: 19/436,665

(22) Filed: Dec. 30, 2025

Related U.S. Application Data
(63) Continuation of application No. PCT/KR2024/009110, filed on Jun. 28, 2024.

(30) Foreign Application Priority Data
Jun. 30, 2023 (KR) 10-2023-0085191
Aug. 17, 2023 (KR) 10-2023-0107906

(51) Int. Cl. H04N 13/398; G06F 21/62; G06F 21/84; G06V 40/10; H04N 13/00; H04N 13/30; H04N 13/305; H04N 13/31; H04N 13/383

(52) U.S. Cl. CPC H04N 13/398; G06F 21/6245; G06F 21/84; H04N 13/383; G06V 40/10; H04N 2013/0081; H04N 13/305; H04N 13/31; H04N 2013/405

(57) ABSTRACT

An electronic device may include a display for displaying a three-dimensional (3D) screen, a camera, a memory for storing instructions, and at least one processor, wherein the instructions, when executed by the at least one processor, cause the electronic device to: identify whether a first screen, corresponding to an application being run on the display and having a two-dimensional image, contains personal information for which security is needed; generate disparity information based on characteristics of the personal information if the first screen contains the personal information; and control the display so that at least a portion of the first screen is displayed as a second screen exhibiting parallax to a left eye and right eye, based on the disparity information.

### CROSS-REFERENCE TO RELATED APPLICATIONS

This application is a continuation of International Application No. PCT/KR2024/009110 designating the United States, filed on Jun. 28, 2024, in the Korean Intellectual Property Receiving Office and claiming priority to Korean Patent Application Nos. 10-2023-0085191, filed on Jun. 30, 2023, and 10-2023-0107906, filed on Aug. 17, 2023, in the Korean Intellectual Property Office, the disclosures of each of which are incorporated by reference herein in their entireties.

### BACKGROUND

### Field

The disclosure relates to an electronic device and a screen display method.

### Description of Related Art

Various electronic devices such as smartphones, tablet PCs, laptop PCs, and wearable devices may include a three-dimensional (3D) display device.

A human may perceive an object stereoscopically through binocular parallax. The 3D display device may display an image three-dimensionally by mimicking an object perception method based on the human binocular parallax.

As the portability of electronic devices such as smartphones, tablet PCs, laptop PCs, and wearable devices has been maximized, a problem arises in that the screen displayed on the display of the electronic device may be visible to others against the user's intention.

An aspect of an electronic device and a screen display method according to the disclosure is to stereoscopically display a screen corresponding to an application being executed, using a 3D display device.

### SUMMARY

The electronic device according to an example embodiment of the disclosure may include a display configured to display a dimensional screen.

The electronic device according to an example embodiment of the disclosure may include a camera disposed on the same plane as the display.

The electronic device according to an example embodiment of the disclosure may include at least one processor, comprising processing circuitry.

The electronic device according to an example embodiment of the disclosure may include a memory configured to store instructions.

The instructions according to an example embodiment of the disclosure, at least one processor, individually and/or collectively, may be configured to execute the instructions and to cause the electronic device to: identify whether a first screen corresponding to an application being executed on the display and having a two-dimensional image includes personal information requiring security, based on the personal information being included, generate disparity information, based on a property of the personal information, and control the display to display at least a part of the first screen as a second screen having parallax between the left eye and the right eye, based on the disparity information.

A screen display method according to an example embodiment of the disclosure may include: identifying whether a first screen corresponding to an application being executed on a display configured to display a three-dimensional screen and having a two-dimensional image includes personal information requiring security.

The screen display method according to an example embodiment of the disclosure may include, based on the personal information being included, generating disparity information, based on a property of the personal information.

The screen display method according to an example embodiment of the disclosure may include controlling the display to display at least a part of the first screen as a second screen having parallax between the left eye and the right eye, based on the disparity information.

An electronic device and screen display method according to the disclosure, may provide a screen corresponding to an application being executed being stereoscopically displayed using a 3D display device, thereby protecting information from others.

### BRIEF DESCRIPTION OF THE DRAWINGS

In relation to the description of drawings, the same or similar elements may be indicated by the same or similar reference signs. Further, the above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments.

FIG. 2A is a diagram illustrating an example electronic device as viewed in a first direction according to various embodiments.

FIG. 2B is a diagram illustrating an example electronic device as viewed in a second direction according to various embodiments.

FIG. 3A is a diagram illustrating an example method of displaying a three-dimensional image by a display according to various embodiments.

FIG. 3B is a diagram illustrating an example method of displaying a three-dimensional image by a display according to various embodiments.

FIG. 4 is a flowchart illustrating an example screen display method of an electronic device according to various embodiments.

FIG. 5 is a flowchart illustrating an example screen display method of an electronic device according to various embodiments.

FIG. 6 is a diagram illustrating an example operation of configuring a secure mode of an electronic device according to various embodiments.

FIG. 7 is a diagram illustrating an example method of registering a user in an electronic device according to various embodiments.

FIG. 8A is a diagram illustrating an example of a text which may be displayed on a display before application of disparity information according to various embodiments.

FIG. 8B is a diagram illustrating an example of a text which may be displayed on a display after application of first disparity information according to various embodiments.

FIG. 8C is a diagram illustrating an example of a text which may be displayed on a display after application of second disparity information according to various embodiments.

FIG. 9A is a diagram illustrating a first execution screen displayed three-dimensionally, when viewed by a user registered in an electronic device of the disclosure according to various embodiments.

FIG. 9B is a perspective view illustrating a first execution screen displayed three-dimensionally, when viewed by a user not registered in an electronic device of the disclosure according to various embodiments.

FIG. 9C is a perspective view illustrating a first execution screen displayed three-dimensionally, when viewed by a user not registered in an electronic device of the disclosure according to various embodiments.

FIG. 10A is a diagram illustrating a second execution screen displayed three-dimensionally, when viewed by a user registered in an electronic device of the disclosure according to various embodiments.

FIG. 10B is a perspective view illustrating a second execution screen displayed three-dimensionally, when viewed by a user not registered in an electronic device of the disclosure according to various embodiments.

FIG. 10C is a perspective view illustrating a first execution screen displayed three-dimensionally, when viewed by a user not registered in an electronic device of the disclosure according to various embodiments.

FIG. 11A is a diagram illustrating a third execution screen displayed three-dimensionally, when viewed by a user registered in an electronic device of the disclosure according to various embodiments.

FIG. 11B is a perspective view illustrating a third execution screen displayed three-dimensionally, when viewed by a user not registered in an electronic device of the disclosure according to various embodiments.

FIG. 11C is a perspective view illustrating a second execution screen displayed three-dimensionally, when viewed by a user not registered in an electronic device of the disclosure according to various embodiments.

FIG. 12A is a diagram illustrating a fourth execution screen displayed three-dimensionally, when viewed by a user registered in an electronic device of the disclosure according to various embodiments.

FIG. 12B is a perspective view illustrating a fourth execution screen displayed three-dimensionally, when viewed by a user not registered in an electronic device of the disclosure according to various embodiments.

FIG. 12C is a perspective view illustrating a fourth execution screen displayed three-dimensionally, when viewed by a user not registered in an electronic device of the disclosure according to various embodiments.

FIG. 13 is a diagram illustrating a fifth execution screen displayed three-dimensionally, when viewed by a user registered in an electronic device of the disclosure according to various embodiments.

FIG. 14A is a diagram illustrating a sixth execution screen displayed three-dimensionally, when viewed by a user registered in an electronic device of the disclosure according to various embodiments.

FIG. 14B is a perspective view illustrating a sixth execution screen displayed three-dimensionally, when viewed by a user registered in an electronic device of the disclosure according to various embodiments.

### DETAILED DESCRIPTION

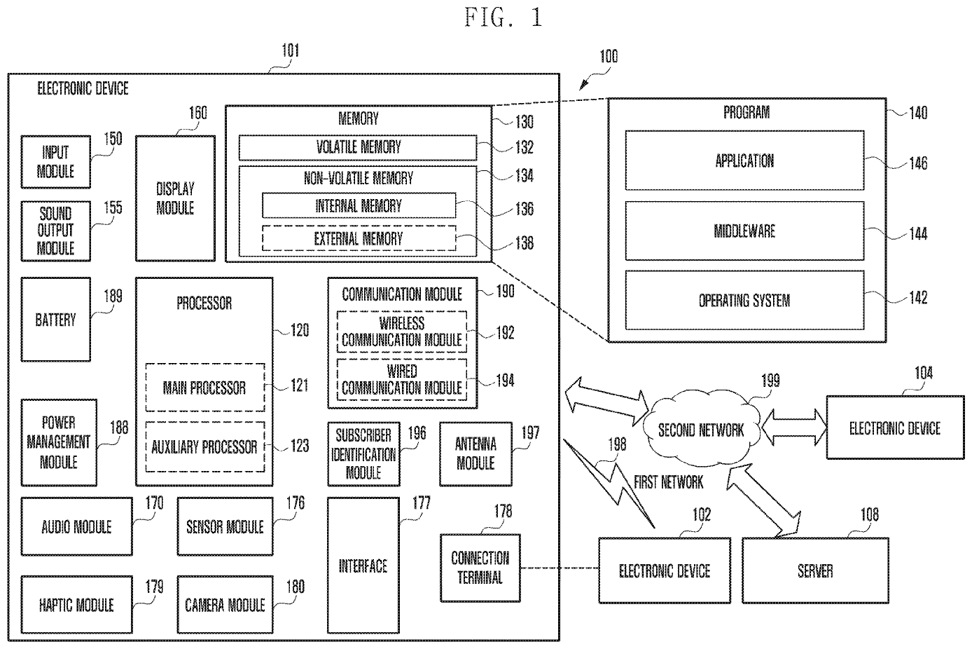

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

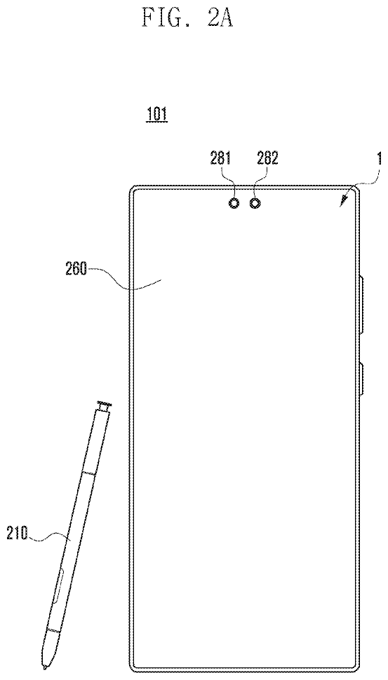

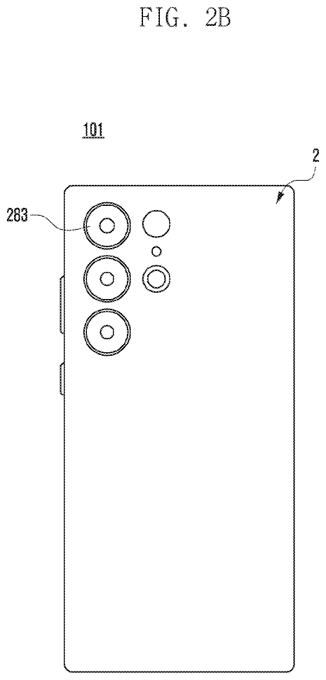

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.
FIG. 2A is a diagram illustrating an example electronic device 101 as viewed in a first direction 1 according to various embodiments.
FIG. 2B is a diagram illustrating an example electronic device 101 as viewed in a second direction 2 according to various embodiments.

In an embodiment, the electronic device 101 may include a display 260, a first camera 281, and an eye tracking sensor 282.

In an embodiment, the display 260 may be the same as the display module 160 in FIG. 1. The display 260 may be a three-dimensional (3D) display. The display 260 may, under the control of the processor 120, display a screen being displayed on the display 260 as a 3D screen with stereoscopic or depth effects, based on binocular parallax. The electronic device 101 may, under the control of the processor 120, generate a first image (or first video) corresponding to the left eye and a second image (or second video) corresponding to the right eye, based on disparity information. The electronic device 101 may, under the control of the processor 120, display the generated first image (or first video) and second image (or second video) simultaneously.

In an embodiment, the user may three-dimensionally recognize the screen displayed on the display 260 only when the user's gaze, the first image (or first video), and the second image (or second video) are aligned. The electronic device 101 may track the user's (or observer's) gaze using the first camera 281 and/or the eye tracking sensor 282. The electronic device 101 may obtain gaze information through the first camera 281 and/or the eye tracking sensor 282. The electronic device 101 may, through the processor 120, control display positions of, on the display 260, the first image (or first video) displayed to the left eye and the second image (or second video) displayed to the right eye, based on the gaze information.

In an embodiment, the disparity information may be information on a degree of separation between an image displayed to the left eye and an image displayed to the right eye when images of different viewpoints are displayed to the left and right eyes. Depending on the degree of separation between an image displayed to the left eye and an image displayed to the right eye, the user may see an image displayed on the display 260 as being stereoscopic or overlapped.

In an embodiment, the first camera 281 may be a vision sensor. The first camera 281 and/or the eye tracking sensor 282 may be disposed on the same plane as the display 260. The first camera 281 may include an image sensor, and may recognize an object (e.g., a face, a hand, a stylus pen 210).

In an embodiment, the eye tracking sensor 282 may detect the positions of the left and right eyes of the user, based on an image acquired by the first camera 281.

In an embodiment, the electronic device 101 may, under the control of the processor 120, identify a line of sight and/or an eye in an image obtained by the first camera 281.

In an embodiment, the electronic device 101 may, under the control of the processor 120, transfer features of the identified line of sight and/or eye to the eye tracking sensor 282.

In an embodiment, the eye tracking sensor 282 may track a line of sight, based on the features of the identified line of sight and/or eye.

In an embodiment, the electronic device 101 may include a second camera 283. The second camera 283 may include at least one of a wide-angle camera, a telephoto camera, and/or a depth camera.

In an embodiment, the first camera 281 and/or the second camera 283 may be the same as the camera module 180 of FIG. 1.

In an embodiment, the display 260 may further include a touch panel for receiving a touch input. The display 260 may receive a touch input of a hand and/or the stylus pen 210. The electronic device 260 may receive an input from the stylus pen 210. The stylus pen 210 may include an input button or an input area.

In an embodiment, the electronic device 101 may, under the control of the processor 120, detect an input (e.g., a touch, hovering, or a button input) received through a hand and/or the stylus pen 210, to control an object (e.g., a three-dimensional object) included in a screen displayed on the display 260.

In an embodiment, the electronic device 101 may, under the control of the processor 120, detect the user's gesture input through the first camera 281 and/or the second camera 283, to control an object (e.g., a three-dimensional object) included in a screen displayed on the display 260.

An operation of controlling an object (e.g., a three-dimensional object) included in a screen displayed on the display 260 may include, for example, a rotation, a movement, and/or a size conversion of the object (e.g., the three-dimensional object).

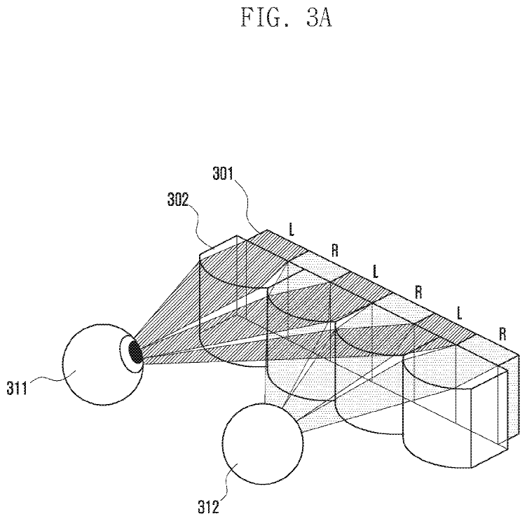

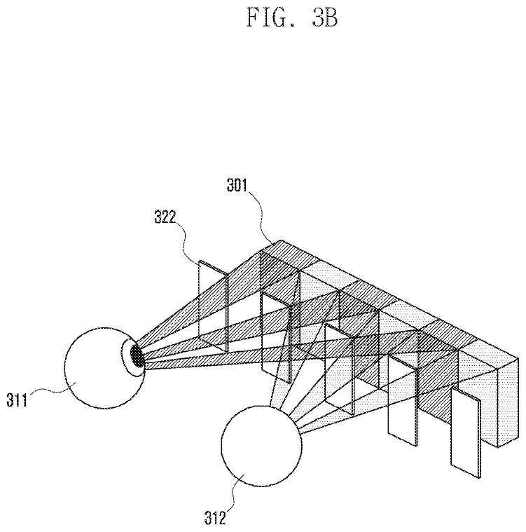

FIG. 3A is a diagram illustrating an example method of displaying a three-dimensional image by the display 260 according to various embodiments.

FIG. 3B is a diagram illustrating an example method of displaying a three-dimensional image by the display 260 according to various embodiments.

In an embodiment, the display 260 capable of displaying a three-dimensional image may include a special slit 302 or 322 in front of a screen 2301 to allow a left eye 311 and a right eye 312 to see different pixels L and R. The slit that causes the left eye 311 and the right eye 312 to see different pixels may be a lenticular lens 302. The slit that causes the left eye 311 and the right eye 312 to see different pixels may be a parallax barrier 322.

In an embodiment, the display 260 may, while displaying an optically separated multi-viewpoint image, cause light rays corresponding to images of different viewpoints to be projected to the user's left eye 311 and right eye 312 using the lenticular lens 302 or the parallax barrier 322, so as to allow the user to perceive a stereoscopic effect.

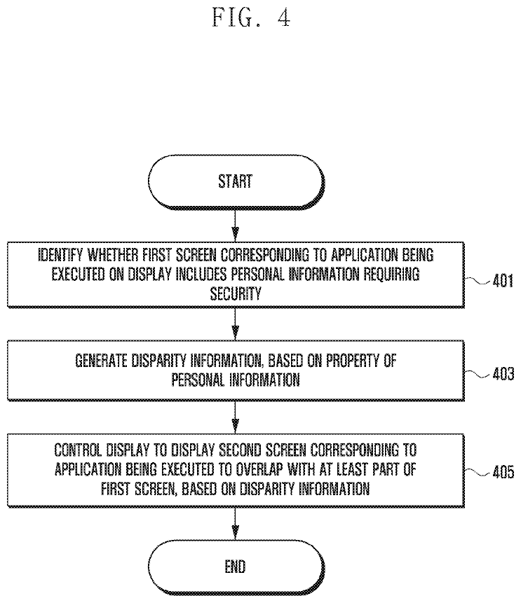

FIG. 4 is a flowchart illustrating an example screen display method of the electronic device 101 according to various embodiments.

In an embodiment, the electronic device 101 may include the memory 130 configured to store instructions. The instructions, when executed by the at least one processor 120, may cause the electronic device 101 to perform a screen display method of the electronic device 101 illustrated in FIG. 4.

In an embodiment, the electronic device 101 may, under control of the processor 120, in operation 401, identify whether a first screen corresponding to an application being executed on the display 260 includes personal information requiring security.

In an embodiment, the instructions, when executed by the at least one processor 120, may cause the electronic device 101 to, in operation 401, identify whether a first screen corresponding to an application being executed on the display 260 includes personal information requiring security.

In an embodiment, the first screen may be a two-dimensionally implemented video or image.

In an embodiment, the personal information may be information enabling direct or indirect identification of each individual, among information on the individual. The personal information may, for example, be an individual's name, signature, address, telephone number, birthday, an individual's password, identification (ID), sensitive information, credit information, employee record information, photos, biometric information, location information, Internet address information, and/or an individual's record (e.g., schedule). The sensitive information may include, for example, information such as race, ethnicity, political views, religion, philosophy, health, and sexual orientation. For example, the personal information may include all information enabling identification of an individual, as well as information on the user of the electronic device 101.

In an embodiment, the electronic device 101 may, under the control of the processor 120, in operation 403, generate disparity information, based on a property of the personal information.

In an embodiment, the instructions, when executed by the at least one processor 120, may cause the electronic device 101 to, in operation 403, generate disparity information, based on a property of the personal information.

In an embodiment, the electronic device 101 may, under the control of the processor 120, in operation 403, when the first screen includes the personal information, generate disparity information, based on a property of the personal information.

In an embodiment, the instructions, when executed by the at least one processor 120, may cause the electronic device 101 to, in operation 403, when the first screen includes the personal information, generate disparity information, based on a property of the personal information.

In an embodiment, the electronic device 101 may, under the control of the processor 120, in operation 403, determine whether the personal information is text or an image, and generate disparity information, based on a result of the determination.

In an embodiment, the instructions, when executed by the at least one processor 120, may cause the electronic device 101 to, in operation 403, determine whether the personal information is text or an image, and generate disparity information, based on a result of the determination.

In an embodiment, the electronic device 101 may pre-store data or a database regarding a property of personal information or personal information in the memory 130. The electronic device 101 may identify whether the information included in the first screen is the personal information, based on the data or database stored in the memory 130. The electronic device 101 may identify a property of the personal information, based on the data or database stored in the memory 130.

In an embodiment, the property of the personal information may be an attribute of the personal information. The property of the personal information may be, for example, metadata. The electronic device 101 may, under the control of the processor 120, determine whether the personal information is text or an image, based on the property of the personal information.

In an embodiment, the electronic device 101 may determine a degree of separation between an image displayed to the left eye and an image displayed to the right eye, based on the property of the personal information. For example, if a degree of separation between an image displayed to the left eye and an image displayed to the right eye is equally applied without considering the property of the personal information, some personal information easily readable by others. In an embodiment, the electronic device 101 may identify a degree of separation between an image displayed to the left eye and an image displayed to the right eye, so that at least one of a size of text, a spacing of text, a font of text, or information on a size of an object included in an image, a shape of an object included in an image, or a color of an object included in an image, which is identified based on the property of the personal information, is not easily readable even when visible to another person. The electronic device 101 may perform control to display a second screen on the display 260, based on the identified degree of separation between the image displayed on the left eye and the image displayed on the right eye.

For example, the electronic device 101 may include, in the memory 130, disparity information corresponding to the size of text, the spacing of text, the font of text, or the information on the size of an object included in an image, the shape of an object included in an image, or the color of an object included in an image, which is identified based on the property of the personal information.

In an embodiment, the electronic device 101 may identify disparity information corresponding to the property of the personal information in the memory 130. Based on the disparity information corresponding to the property of the personal information, the electronic device 101 may perform control to display a second screen on the display 260.

The electronic device 101 may, under the control of the processor 120, when it is determined that the personal information includes text, generate disparity information, based on at least one of a size, a spacing, and a font of the text. When the personal information includes text, a property of the personal information may include at least one of a size, a spacing, and a font of the text.

In an embodiment, the electronic device 101 may, under the control of the processor 120, in operation 403, when it is determined that the personal information includes an image (e.g., photo), identify an object included in the image.

In an embodiment, the instructions, when executed by the at least one processor 120, may cause the electronic device 101 to, in operation 403, when it is determined that the personal information includes an image (e.g., photo), identify an object included in the image.

In an embodiment, the electronic device 101 may, under the control of the processor 120, in operation 403, generate disparity information, based on a property of the object included in the image.

In an embodiment, the instructions, when executed by the at least one processor 120, may cause the electronic device 101 to, in operation 403, generate disparity information, based on a property of the object included in the image.

In an embodiment, the object included in the image may include, for example, a thing, an animal, a person, and/or text. The electronic device 101 may, under the control of the processor 120, in operation 403, identify at least one of pieces of information on a size, a shape, or a color of the object included in the image. When the personal information includes an image, a property of the personal information may include at least one of pieces of information on a size, a shape, or a color of an object included in the image.

In an embodiment, the electronic device 101 may, under the control of the processor 120, in operation 403, when the personal information includes an image (e.g., photo), generate disparity information, based on at least one of pieces of information on a size, a shape, or a color of an object included in the image.

In an embodiment, the instructions, when executed by the at least one processor 120, may cause the electronic device 101 to, in operation 403, when the personal information includes an image (e.g., photo), generate disparity information, based on at least one of pieces of information on a size, a shape, or a color of an object included in the image.

In an embodiment, when the object included in the image is text, the electronic device 101 may, under the control of the processor 120, in operation 403, generate disparity information, based on at least one of a size, a spacing, and a font of the text.

In an embodiment, the instructions, when executed by the at least one processor 120, may cause the electronic device 101 to, in operation 403, when the object included in the image is text, generate disparity information, based on at least one of a size, a spacing, and a font of the text.

In an embodiment, the disparity information may be information on a degree of separation between an image displayed to the left eye and an image displayed to the right eye when images of different viewpoints for the left and right eyes are displayed on the display 260.

In an embodiment, the electronic device 101 may obtain gaze information through the first camera 281 and/or the eye tracking sensor 282. The electronic device 101 may, through the processor 120, control display positions of, on the display 260, a first video (or first image) displayed to the left eye and a second video (or second image) displayed to the right eye, based on the gaze information.

In an embodiment, the electronic device 101 displays a three-dimensional image (or video) on the display 260 to correspond to a user whose gaze is being tracked. Therefore, when a user whose gaze is not being tracked views the display 260, the first video (or first image) displayed to the left eye and the second video (or second image) displayed to the right eye may be seen as separated or overlapped according to disparity information (or a degree of separation), making it difficult to read text included in personal information. When a degree of separation becomes greater than a designated range, a person other than the user may unintentionally be able to read the text. Therefore, the electronic device 101 may generate disparity information, based on a property of personal information.

In an embodiment, the electronic device 101 may, under the control of the processor 120, in operation 405, control the display 260 to display a second screen corresponding to the application being executed to overlap with at least a part of the first screen, based on the disparity information. The electronic device 101 may, under the control of the processor 120, perform control to display the second screen to correspond to the gaze of a subject (e.g., a registered user) whose line of sight is tracked by the first camera 281.

In an embodiment, the instructions, when executed by the at least one processor 120, may cause the electronic device 101 to, in operation 405, control the display 260 to display a second screen corresponding to the application being executed to overlap with at least a part of the first screen, based on the disparity information.

In an embodiment, the electronic device 101 may, under the control of the processor 120, in operation 405, control the display 260 to display at least a part of the first screen as a second screen having parallax between the left eye and the right eye, based on the disparity information.

In an embodiment, the instructions, when executed by the at least one processor 120, may cause the electronic device 101 to, in operation 405, control the display 260 to display at least a part of the first screen as a second screen having parallax between the left eye and the right eye, based on the disparity information.

In an embodiment, the second screen may be a three-dimensionally displayed video or image. Since a first video (or first image) displayed to the left eye and a second video (or second image) displayed to the right eye in the second screen are separated and displayed on the display 260, at least a part of the first video (or first image) displayed to the left eye and the second video (or second image) displayed to the right eye may be seen as overlapped. A degree of overlap between the first video (or first image) displayed to the left eye and the second video (or second image) displayed to the right eye may vary depending on an angle at which the display 260 is viewed.

In an embodiment, when displaying the second screen, the electronic device 101 may, under the control of the processor 120, display the entirety of the second screen as a three-dimensional implemented video or image. In an embodiment, when displaying the second screen, the electronic device 101 may, under the control of the processor 120, display an area of the second screen corresponding to the personal information as a three-dimensional implemented video or image.

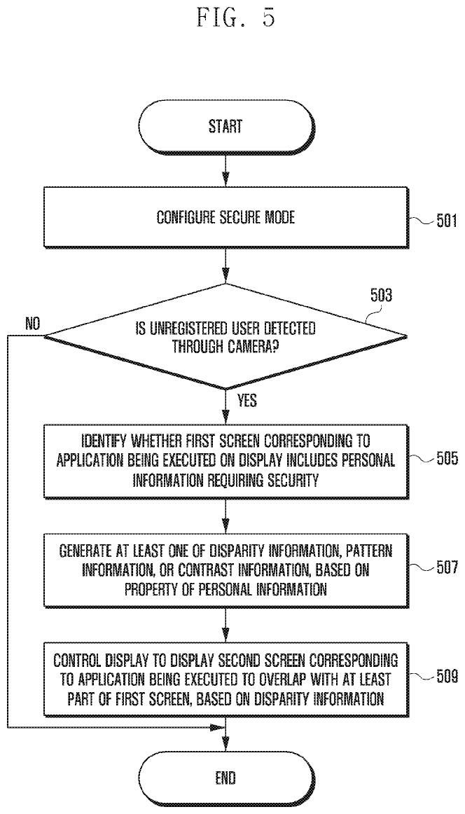

FIG. 5 is a flowchart illustrating an example screen display method of the electronic device 101 according to various embodiments.

In an embodiment, the electronic device 101 may include the memory 130 configured to store instructions. The instructions, when executed by the at least one processor 120, may cause the electronic device 101 to perform a screen display method of the electronic device 101 illustrated in FIG. 5.

In an embodiment, the electronic device 101 may, under the control of the processor 120, in operation 501, configure a secure mode.

In an embodiment, the instructions, when executed by the at least one processor 120, may cause the electronic device 101 to, in operation 501, configure a secure mode.

In an embodiment, a secure mode may correspond to an operation of performing control the entirety of a screen including personal information and/or on an area including the personal information as a three-dimensionally displayed video or an image. The secure mode may be turned on/off according to a user's configuration.

In an embodiment, when the secure mode is turned on or configured, the electronic device 101 may display the entirety of a screen including personal information on the display 260 and/or on an area including the personal information as a three-dimensionally displayed video or an image. When the secure mode is turned off, the electronic device 101 may display the screen on the display 260 two-dimensionally.

In an embodiment, when the secure mode is turned on or configured, if it is determined that a user other than a registered user is viewing the display 260, the electronic device 101 may display the entirety of a screen including personal information and/or on an area including the personal information as a three-dimensionally displayed video or an image.

In an embodiment, the electronic device 101 may execute a setting application and/or a control panel enabling configuration of the secure mode, based on a user's input.

In an embodiment, the electronic device 101 may, under the control of the processor 120, in operation 503, determine whether an unregistered user is detected through a camera (e.g., the first camera 281).

In an embodiment, the instructions, when executed by the at least one processor 120, may cause the electronic device 101 to, in operation 503, determine whether an unregistered user is detected through a camera (e.g., the first camera 281). In an embodiment, the electronic device 101 may, under the control of the processor 120, in operation 503, determine whether an unregistered user is detected through a camera (e.g., the first camera 281).

In an embodiment, the instructions, when executed by the at least one processor 120, may cause the electronic device 101 to, in operation 503, determine whether an unregistered user is detected through a camera (e.g., the first camera 281).

In an embodiment, when the unregistered user is detected (“Yes” in operation 503), the electronic device 101 may proceed to operation 505 from operation 503.

In an embodiment, when the unregistered user is not detected (“No” in operation 503) or when the registered user is detected, the electronic device 101 may continuously display the screen being executed.

In an embodiment, the electronic device 101 may, under the control of the processor 120, in operation 503, determine whether eyes of multiple users are detected through a camera (e.g., the first camera 281).

In an embodiment, the instructions, when executed by the at least one processor 120, may cause the electronic device 101 to, in operation 503, determine whether eyes of multiple users are detected through a camera (e.g., the first camera 281).

In an embodiment, when the eyes of the multiple users are detected, the electronic device 101 may proceed to operation 505 from operation 503.

In an embodiment, when the eyes of the multiple users are not detected and only the eyes of the registered user are detected, the electronic device 101 may continuously display the screen being executed.

In an embodiment, the electronic device 101 may, under the control of the processor 120, in operation 503, determine whether a user is detected through a camera (e.g., the first camera 281).

In an embodiment, the instructions, when executed by the at least one processor 120, may cause the electronic device 101 to, in operation 503, determine whether a user is detected through a camera (e.g., the first camera 281).

In an embodiment, when the user is not detected, the electronic device 101 may proceed to operation 505 from operation 503.

In an embodiment, when the user (e.g., the registered user) is detected, the electronic device 101 may continuously display the screen being executed.

However, the disclosure is not limited thereto, operation 503 may be omitted, and when the secure mode is turned on or configured, operation 505 may proceed from operation 501. In operation 501, when the secure mode is not configured, the electronic device 101 may continuously display the screen being executed.

In an embodiment, the electronic device 101 may, under control of the processor 120, in operation 505, identify whether a first screen corresponding to an application being executed on the display 260 includes personal information requiring security.

In an embodiment, the instructions, when executed by the at least one processor 120, may cause the electronic device 101 to, in operation 505, identify whether a first screen corresponding to an application being executed on the display 260 includes personal information requiring security.

In an embodiment, the first screen may be a two-dimensionally implemented video or image.

In an embodiment, the electronic device 101 may, under the control of the processor 120, in operation 507, generate at least one of disparity information, pattern information, or contrast information, based on a property of the personal information.

In an embodiment, the instructions, when executed by the at least one processor 120, may cause the electronic device 101 to, in operation 507, generate at least one of disparity information, pattern information, or contrast information, based on a property of the personal information.

In an embodiment, the electronic device 101 may, under the control of the processor 120, in operation 507, when the first screen includes the personal information, generate at least one of disparity information, pattern information, or contrast information, based on a property of the personal information.

In an embodiment, the instructions, when executed by the at least one processor 120, may cause the electronic device 101 to, in operation 507, when the first screen includes the personal information, generate at least one of disparity information, pattern information, or contrast information, based on a property of the personal information.

In an embodiment, the electronic device 101 may, under the control of the processor 120, in operation 507, determine whether the personal information is text or an image, and generate disparity information, based on a result of the determination.

In an embodiment, the instructions, when executed by the at least one processor 120, may cause the electronic device 101 to, in operation 507, determine whether the personal information is text or an image, and generate disparity information, based on a result of the determination.

In an embodiment, the property of the personal information may be an attribute of the personal information. The property of the personal information may be, for example, metadata. The electronic device 101 may, under the control of the processor 120, determine whether the personal information is text or an image, based on the property of the personal information.

In an embodiment, the electronic device 101 may determine a degree of separation between an image displayed to the left eye and an image displayed to the right eye, based on the property of the personal information. For example, if a degree of separation between an image displayed to the left eye and an image displayed to the right eye is equally applied without considering the property of the personal information, some personal information easily readable by others. In an embodiment, the electronic device 101 may identify a degree of separation between an image displayed to the left eye and an image displayed to the right eye, so that at least one of a size of text, a spacing of text, a font of text, or information on a size of an object included in an image, a shape of an object included in an image, or a color of an object included in an image, which is identified based on the property of the personal information, is not easily readable even when visible to another person. The electronic device 101 may perform control to display a second screen on the display 260, based on the identified degree of separation between the image displayed on the left eye and the image displayed on the right eye.

For example, the electronic device 101 may include, in the memory 130, disparity information corresponding to the size of text, the spacing of text, the font of text, or the information on the size of an object included in an image, the shape of an object included in an image, or the color of an object included in an image, which is identified based on the property of the personal information.

In an embodiment, the electronic device 101 may identify disparity information corresponding to the property of the personal information in the memory 130. Based on the disparity information corresponding to the property of the personal information, the electronic device 101 may perform control to display a second screen on the display 260.

In an embodiment, the electronic device 101 may, under the control of the processor 120, when it is determined that the personal information includes text, generate disparity information, based on at least one of a size, a spacing, and a font of the text. When the personal information includes text, a property of the personal information may include at least one of a size, a spacing, and a font of the text.

In an embodiment, the electronic device 101 may, under the control of the processor 120, in operation 507, when it is determined that the personal information includes an image (e.g., photo), identify an object included in the image.

In an embodiment, the instructions, when executed by the at least one processor 120, may cause the electronic device 101 to, in operation 507, when it is determined that the personal information includes an image (e.g., photo), identify an object included in the image.

In an embodiment, the electronic device 101 may, under the control of the processor 120, in operation 507, generate disparity information, based on a property of the object included in the image.

In an embodiment, the instructions, when executed by the at least one processor 120, may cause the electronic device 101 to, in operation 507, generate disparity information, based on a property of the object included in the image.

In an embodiment, the object included in the image may include, for example, a thing, an animal, a person, and/or text. The electronic device 101 may, under the control of the processor 120, in operation 507, identify at least one of pieces of information on a size, a shape, or a color of the object included in the image. When the personal information includes an image, a property of the personal information may include at least one of pieces of information on a size, a shape, or a color of an object included in the image.

In an embodiment, the electronic device 101 may, under the control of the processor 120, in operation 507, when the personal information includes an image (e.g., photo), generate disparity information, based on at least one of pieces of information on a size, a shape, or a color of an object included in the image.

In an embodiment, the instructions, when executed by the at least one processor 120, may cause the electronic device 101 to, in operation 507, when the personal information includes an image (e.g., photo), generate disparity information, based on at least one of pieces of information on a size, a shape, or a color of an object included in the image.

In an embodiment, when the object included in the image is text, the electronic device 101 may, under the control of the processor 120, in operation 507, generate disparity information, based on at least one of a size, a spacing, and a font of the text.

In an embodiment, the instructions, when executed by the at least one processor 120, may cause the electronic device 101 to, in operation 507, generate disparity information, based on at least one of a size, a spacing, and a font of the text.

In an embodiment, the disparity information may be information on a degree of separation between an image displayed to the left eye and an image displayed to the right eye when images of different viewpoints for the left and right eyes are displayed on the display 260.

In an embodiment, the electronic device 101 may obtain gaze information through the first camera 281 and/or the eye tracking sensor 282. The electronic device 101 may, through the processor 120, control display positions of, on the display 260, a first video (or first image) displayed to the left eye and a second video (or second image) displayed to the right eye, based on the gaze information.

In an embodiment, the electronic device 101 displays a three-dimensional image (or video) on the display 260 to correspond to a user whose gaze is being tracked. Therefore, when a user whose gaze is not being tracked views the display 260, the first video (or first image) displayed to the left eye and the second video (or second image) displayed to the right eye may be seen as separated or overlapped according to disparity information (or a degree of separation), making it difficult to read text included in personal information. When a degree of separation becomes greater than a designated range, a person other than the user may unintentionally be able to read the text. Therefore, the electronic device 101 may generate disparity information, based on a property of personal information.

In an embodiment, the pattern information may be information overlapping with and/or added to a three-dimensional image (or video) being displayed on the display 260. For example, the pattern information may include a stripe pattern. A pattern included in the pattern information may be semi-transparent.

In an embodiment, the electronic device 101 may display a pattern included in the pattern information to overlap with the three-dimensional image (or video) being displayed on the display 260.

In an embodiment, the contrast information may be information overlapping with and/or added to a three-dimensional image (or video) being displayed on the display 260. The contrast information may include a contrast ratio of the display 260.

In an embodiment, the electronic device 101 may change the contrast ratio of the three-dimensional image (or video) being displayed on the display 260 and display same, based on the contrast information.

In an embodiment, the electronic device 101 may, under the control of the processor 120, in operation 509, control the display 260 to display a second screen corresponding to the application being executed to overlap with at least a part of the first screen, based on the at least one of the disparity information, the pattern information, or the contrast information.

In an embodiment, the instructions, when executed by the at least one processor 120, may cause the electronic device 101 to, in operation 509, control the display 260 to display a second screen corresponding to the application being executed to overlap with at least a part of the first screen, based on the at least one of the disparity information, the pattern information, or the contrast information.

In an embodiment, the electronic device 101 may, under the control of the processor 120, in operation 509, control the display 260 to display at least a part of the first screen as a second screen having parallax between the left eye and the right eye, based on the at least one of the disparity information, the pattern information, or the contrast information.

In an embodiment, the instructions, when executed by the at least one processor 120, may cause the electronic device 101 to, in operation 509, control the display 260 to display at least a part of the first screen as a second screen having parallax between the left eye and the right eye, based on the at least one of the disparity information, the pattern information, or the contrast information.

In an embodiment, the electronic device 101 may, under the control of the processor 120, perform control to display the second screen to correspond to the gaze of a subject (e.g., a registered user) whose line of sight is tracked by the first camera 281.

In an embodiment, the second screen may be a three-dimensionally displayed video or image. The second screen may be a screen in which a pattern included in the pattern information is displayed to overlap with a three-dimensionally displayed video or image. The second screen may be a screen in which the contrast ratio of a three-dimensionally displayed video or image is changed based on the contrast information.

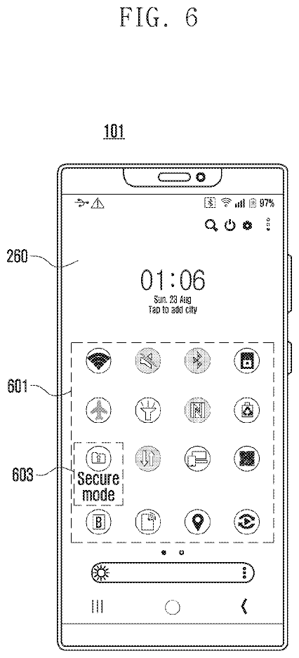

FIG. 6 is a diagram illustrating an example operation of configuring a secure mode of the electronic device 101 according to various embodiments.

In an embodiment, the electronic device 101 may, under the control of the processor 160, execute a control panel 601 when a user input is received. The control panel 601 may be an execution screen of a setting application. The control panel 601 may be an API enabling access to the setting application. For example, the control panel 601 may turn on or off at least one configuration such as Wi-Fi connection, airplane mode, near field communication, and/or audio volume mute according to the user's input. The control panel 601 may include a configuration related to a secure mode 603. The secure mode 603 may be turned on or off according to the user's input.

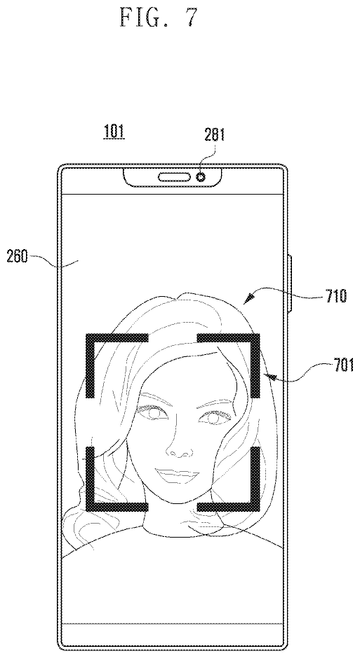

FIG. 7 is a diagram illustrating an example method of registering a user in the electronic device 101 according to various embodiments.

In an embodiment, the electronic device 101 may, under the control of the processor 120, register a user 710 using the first camera 281 and display a registration process 701 or a success or failure 701 of recognition on the display 260.

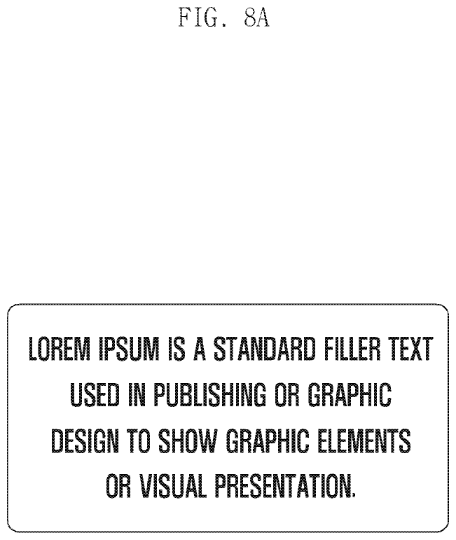

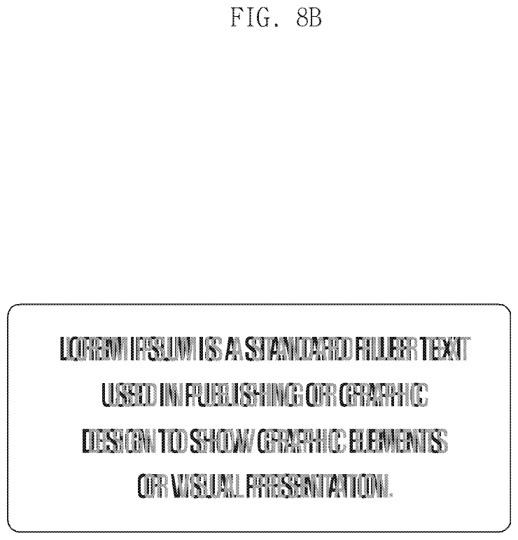

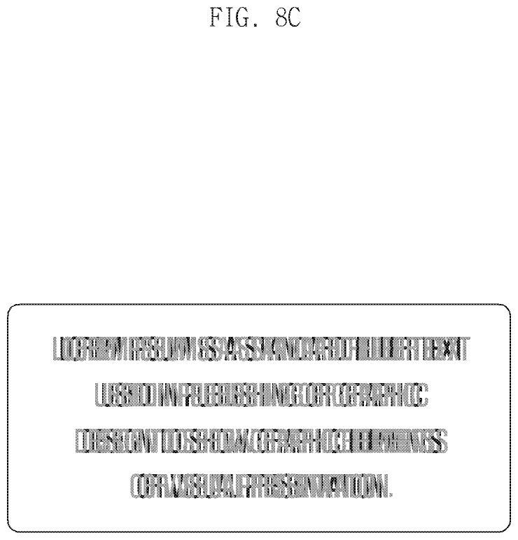

FIG. 8A is a diagram illustrating an example of a text which may be displayed on the display 260 before application of disparity information according to various embodiments.

FIG. 8B is a diagram illustrating an example of a text which may be displayed on the display 260 after application of first disparity information according to various embodiments.

FIG. 8C is a diagram illustrating an example of a text which may be displayed on the display 260 after application of second disparity information according to various embodiments.

Referring to FIG. 8A, a text which may be displayed on the display 260 before application of disparity information may be, for example, “Lorem Ipsum is a standard filler text used in publishing or graphic design to show graphic elements or visual presentation.”

Referring to FIG. 8B and FIG. 8C, when first disparity information or second disparity information is applied, the electronic device 101 may separately display a first video (or first image) displayed to the left eye and a second video (or second image) displayed to the right eye, the videos including the text “Lorem Ipsum is a standard filler text used in publishing or graphic design to show graphic elements or visual presentation,” based on the first disparity information or the second disparity information. When the first video (or first image) displayed to the left eye and the second video (or second image) displayed to the right eye are separately displayed, the texts may be displayed as overlapped according to an angle at which the user is viewing.

A degree of separation between the first video (or first image) displayed to the left eye and the second video (or second image) displayed to the right eye, which is included in the second disparity information, may be larger than a degree of separation of the first disparity information. The electronic device 101 may, under the control of the processor 120, determine a degree of separation or disparity information, based on a size of text, a spacing of text, and/or a font (or typeface). For example, when the size of a text displayed on the display 260 is A cm, the electronic device 101 may determine a degree of separation or disparity information as a range from ½ A cm to A cm corresponding to half of the text size. Even when the degree of separation or the disparity information is determined to be a range from ½ A cm to A cm corresponding to the half of the text size, if the text includes a spacing or font allowing a part of the text to be recognized, the electronic device 101 may adjust the degree of separation or the disparity information under the control of the processor 120.

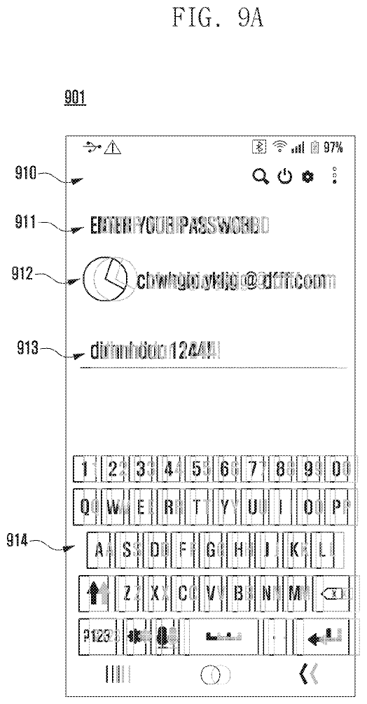

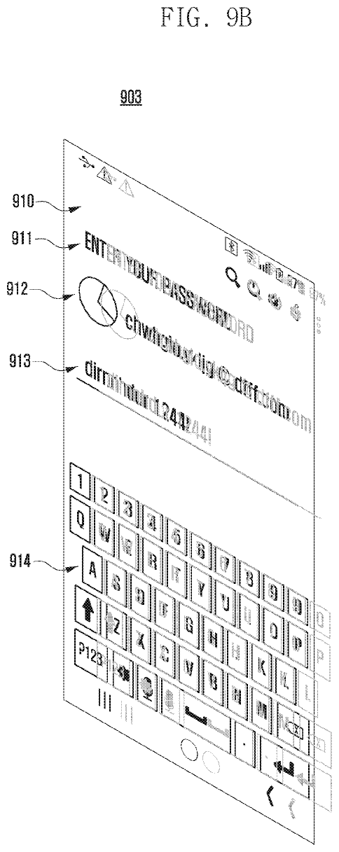

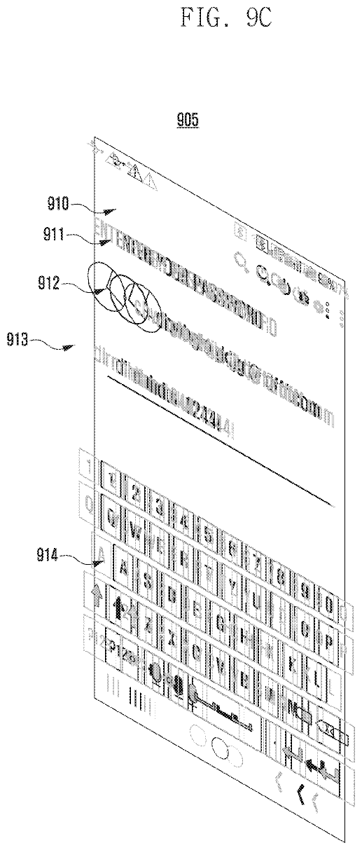

FIG. 9A is a diagram illustrating a first execution screen 910 displayed three-dimensionally, when viewed by a user registered in the electronic device 101 of the disclosure according to various embodiments.

FIG. 9B is a perspective view illustrating the first execution screen 910 displayed three-dimensionally, when viewed by a user not registered in the electronic device 101 of the disclosure according to various embodiments.

FIG. 9C is a perspective view illustrating the first execution screen 910 displayed three-dimensionally, when viewed by a user not registered in the electronic device 101 of the disclosure according to various embodiments.

An application being executed in FIG. 9A, FIG. 9B, and FIG. 9C may be a browser. The first execution screen 910 may be a login interface of an Internet address accessed through the browser. The first execution screen 910 may include, as a user interface, a guidance text 911 such as “Enter your password,” an ID 912 for login, a password 913 for login, and a virtual keypad 914.

In an embodiment, the electronic device 101 may, under the control of the processor 120, identify whether the first execution screen 910 of the browser, which is an application being executed, includes personal information requiring security.

In an embodiment, when the first execution screen 910 includes personal information such as the ID 912 for login or the password 913 for login, the electronic device 101 may, under the control of the processor 120, generate disparity information, based on a property of the personal information. The personal information included in the first execution screen 910 may be text.

In an embodiment, the electronic device 101 may, under the control of the processor 120, separately display, on the display 260, a first video (or first image) displayed to the left eye and a second video (or second image) displayed to the right eye as the first execution screen 910, based on the disparity information.

A screen 901 may be a three-dimensional screen viewed by a user registered in the electronic device 101. The electronic device 101 may adjust and display the first video (or first image) displayed to the left eye and the second video (or second image) displayed to the right eye by tracking the registered user's gaze, and thus a degree to which the images are seen as overlapped may be small.

A screen 903 and a screen 905 may be three-dimensional screens viewed by a user not registered in the electronic device 101. The first video (or first image) displayed to the left eye and the second video (or second image) displayed to the right eye overlap with each other, and thus the unregistered user may have difficulty in identifying the content of the personal information. The screen 903 may be a three-dimensional screen implemented in a form of receding inward, and the screen 905 may be a three-dimensional screen implemented in a form of protruding outward.

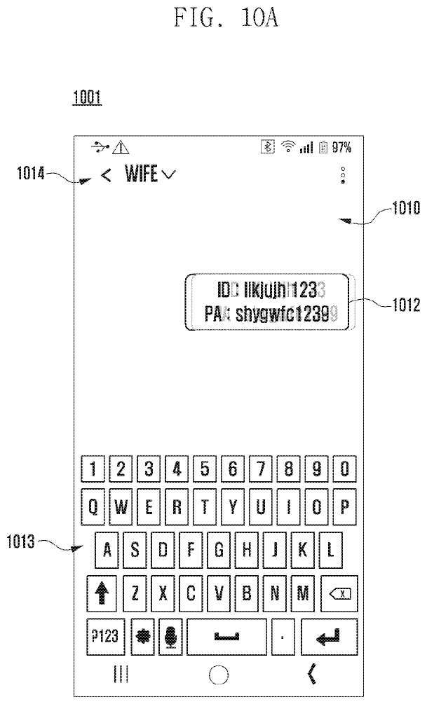

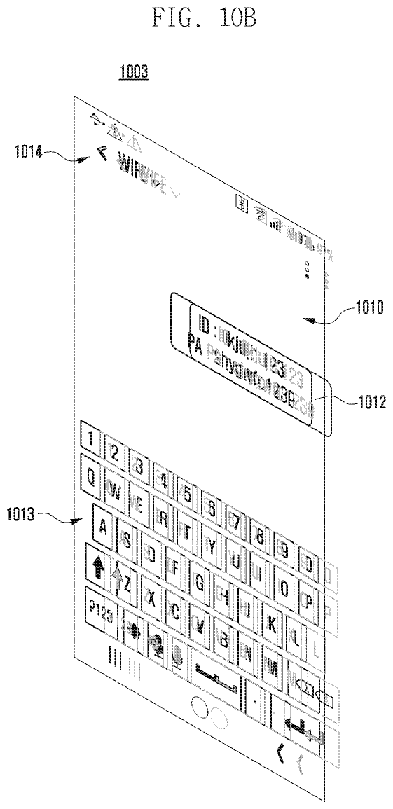

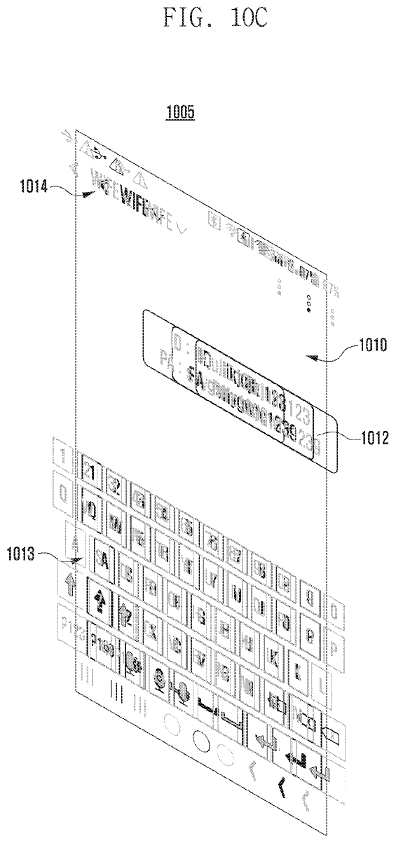

FIG. 10A is a diagram illustrating a second execution screen 1010 displayed three-dimensionally, when viewed by a user registered in the electronic device 101 of the disclosure according to various embodiments.

FIG. 10B is a perspective view illustrating the second execution screen 1010 displayed three-dimensionally, when viewed by a user not registered in the electronic device 101 of the disclosure according to various embodiments.

FIG. 10C is a perspective view illustrating the first execution screen 1010 that is displayed three-dimensionally, when viewed by a user not registered in the electronic device 101 of the disclosure according to various embodiments.

An application being executed in FIG. 10A, FIG. 10B, and FIG. 10C may be a messenger. The second execution screen 1010 may be an interface of the messenger. The second execution screen 1010 may include, as a user interface, a reception message text such as “Please tell me your ID and password” transmitted from a chat partner, a transmission text 1012 such as “ID and password,” a virtual keypad 1013, and/or a text 1014 regarding a chat partner such as “Wife.”

In an embodiment, the electronic device 101 may, under the control of the processor 120, identify whether the second execution screen 1010 of the messenger, which is an application being executed, includes personal information requiring security.

In an embodiment, when the second execution screen 1010 includes personal information such as the transmission text 1012, the electronic device 101 may, under the control of the processor 120, generate disparity information, based on a property of the personal information. The personal information included in the second execution screen 1010 may be text.

In an embodiment, the electronic device 101 may, under the control of the processor 120, separately display, on the display 260, a first video (or first image) displayed to the left eye and a second video (or second image) displayed to the right eye as the second execution screen 1010, based on the disparity information.

A screen 1001 may be a three-dimensional screen viewed by a user registered in the electronic device 101. The electronic device 101 may adjust and display the first video (or first image) displayed to the left eye and the second video (or second image) displayed to the right eye by tracking the registered user's gaze, and thus a degree to which the images are seen as overlapped may be small.

A screen 1003 and a screen 1005 may be three-dimensional screens viewed by a user not registered in the electronic device 101. The first video (or first image) displayed to the left eye and the second video (or second image) displayed to the right eye overlap with each other, and thus the unregistered user may have difficulty in identifying the content of the personal information. The screen 1003 may be a three-dimensional screen implemented in a form of receding inward, and the screen 1005 may be a three-dimensional screen implemented in a form of protruding outward.

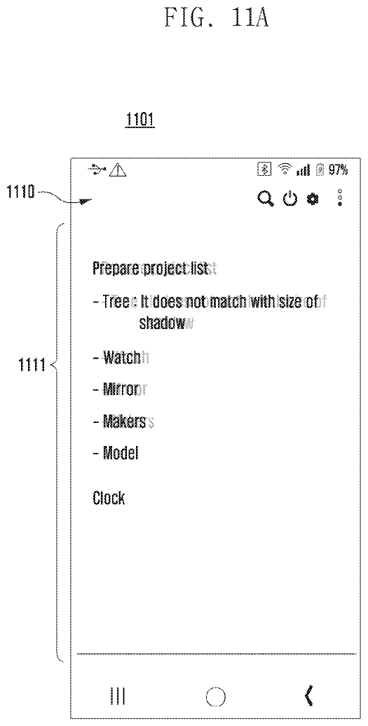

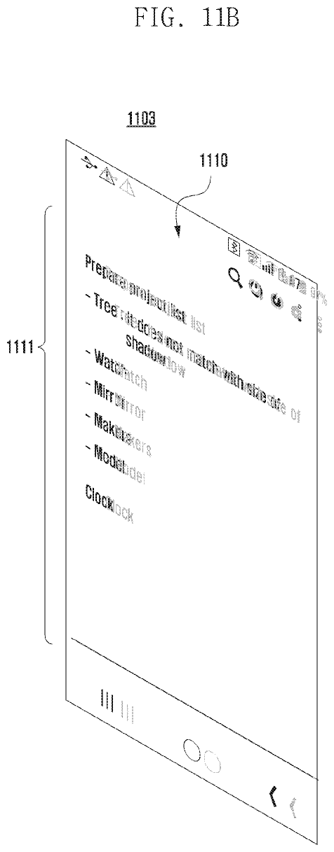

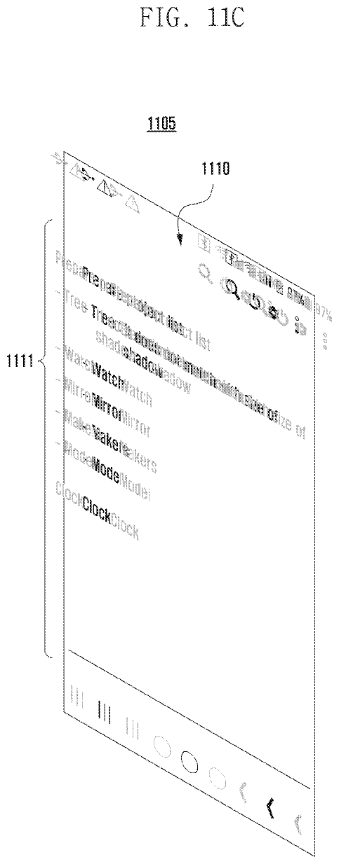

FIG. 11A is a diagram illustrating a third execution screen 1110 displayed three-dimensionally, when viewed by a user registered in the electronic device 101 of the disclosure according to various embodiments.

FIG. 11B is a perspective view illustrating the third execution screen 1110 displayed three-dimensionally, when viewed by a user not registered in the electronic device 101 of the disclosure according to various embodiments.

FIG. 11C is a perspective view illustrating the second execution screen 1110 displayed three-dimensionally, when viewed by a user not registered in the electronic device 101 of the disclosure according to various embodiments.

An application being executed in FIG. 11A, FIG. 11B, and FIG. 11C may be a memo application. The third execution screen 1110 may be an interface of the memo application. The third execution screen 1110 may include, as a user interface, personal information such as memo content 1111. For example, the memo content 1111 may include content about parts to be corrected or items to be added by a memo writer when preparing for drawing while performing a task such as drawing, for instance, “prepare project list,” “tree: it does not match with size of shadow,” or “watch.”

In an embodiment, the electronic device 101 may, under the control of the processor 120, identify whether the third execution screen 1110 of the memo application, which is an application being executed, includes personal information requiring security.

In an embodiment, when the third execution screen 1110 includes personal information such as the memo content 1111, the electronic device 101 may, under the control of the processor 120, generate disparity information, based on a property of the personal information. The personal information included in the third execution screen 1110 may be text.

In an embodiment, the electronic device 101 may, under the control of the processor 120, separately display, on the display 260, a first video (or first image) displayed to the left eye and a second video (or second image) displayed to the right eye as the third execution screen 1110, based on the disparity information.

A screen 1101 may be a three-dimensional screen viewed by a user registered in the electronic device 101. The electronic device 101 may adjust and display the first video (or first image) displayed to the left eye and the second video (or second image) displayed to the right eye by tracking the registered user's gaze, and thus a degree to which the images are seen as overlapped may be small.

A screen 1103 and a screen 1105 may be three-dimensional screens viewed by a user not registered in the electronic device 101. The first video (or first image) displayed to the left eye and the second video (or second image) displayed to the right eye overlap with each other, and thus the unregistered user may have difficulty in identifying the content of the personal information. The screen 1103 may be a three-dimensional screen implemented in a form of receding inward, and the screen 1105 may be a three-dimensional screen implemented in a form of protruding outward.

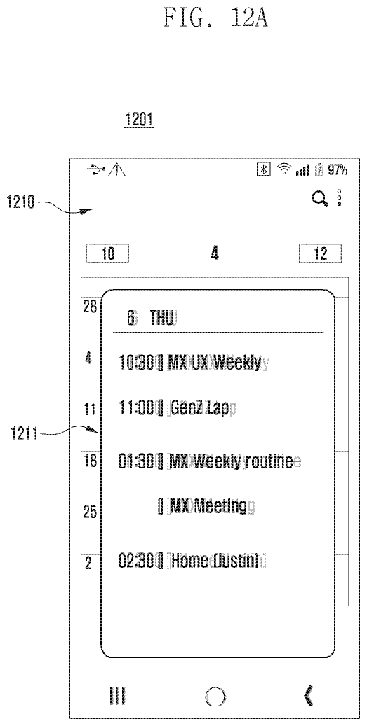

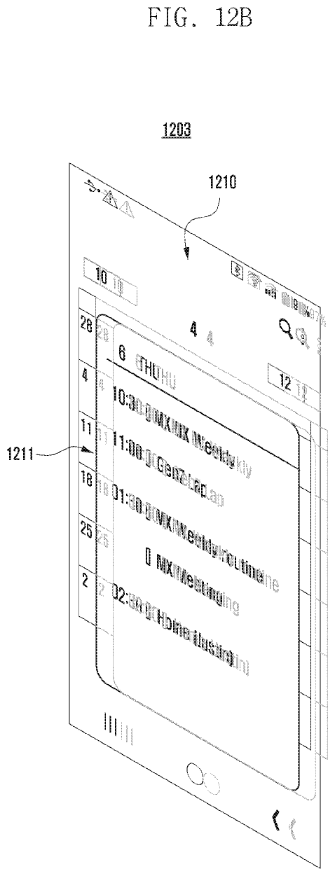

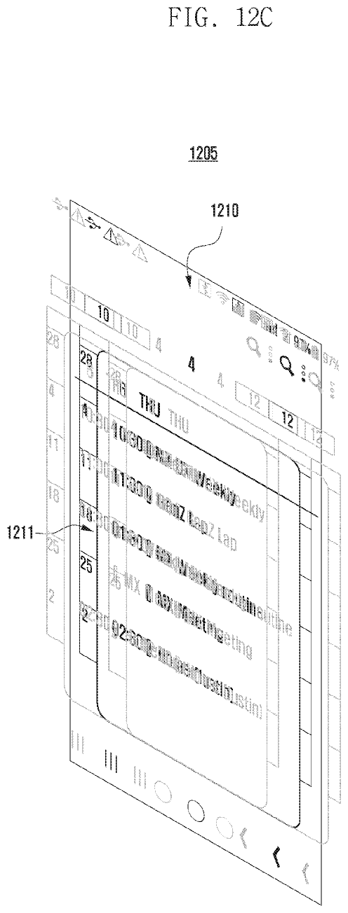

FIG. 12A is a diagram illustrating a fourth execution screen 1210 displayed three-dimensionally, when viewed by a user registered in the electronic device 101 of the disclosure according to various embodiments.

FIG. 12B is a perspective view illustrating the fourth execution screen 1210 that is displayed three-dimensionally, when viewed by a user not registered in the electronic device 101 of the disclosure according to various embodiments.

FIG. 12C is a perspective view illustrating the fourth execution screen 1210 that is displayed three-dimensionally, when viewed by a user not registered in the electronic device 101 of the disclosure according to various embodiments.

An application being executed in FIG. 12A, FIG. 12B, and FIG. 12C may be a scheduler or calendar. The fourth execution screen 1210 may be an interface of the scheduler or calendar. The fourth execution screen 1210 may include, as a user interface, personal information such as a schedule reservation 1211.

In an embodiment, the electronic device 101 may, under the control of the processor 120, identify whether the fourth execution screen 1210 of the scheduler or calendar, which is an application being executed, includes personal information requiring security.

In an embodiment, when the fourth execution screen 1210 includes personal information such as the schedule reservation 1211, the electronic device 101 may, under the control of the processor 120, generate disparity information, based on a property of the personal information. The personal information included in the fourth execution screen 1210 may be text.

In an embodiment, the electronic device 101 may, under the control of the processor 120, separately display, on the display 260, a first video (or first image) displayed to the left eye and a second video (or second image) displayed to the right eye as the fourth execution screen 1210, based on the disparity information.

A screen 1201 may be a three-dimensional screen viewed by a user registered in the electronic device 101. The electronic device 101 may adjust and display the first video (or first image) displayed to the left eye and the second video (or second image) displayed to the right eye by tracking the registered user's gaze, and thus a degree to which the images are seen as overlapped may be small.

A screen 1203 and a screen 1205 may be three-dimensional screens viewed by a user not registered in the electronic device 101. The first video (or first image) displayed to the left eye and the second video (or second image) displayed to the right eye overlap with each other, and thus the unregistered user may have difficulty in identifying the content of the personal information. The screen 1203 may be a three-dimensional screen implemented in a form of receding inward, and the screen 1205 may be a three-dimensional screen implemented in a form of protruding outward.

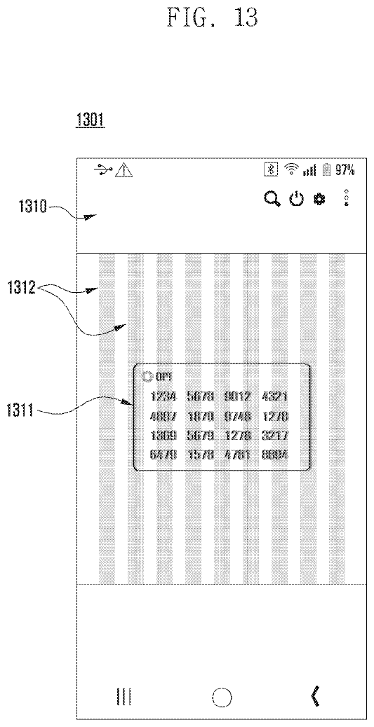

FIG. 13 is a diagram illustrating a fifth execution screen 1310 displayed three-dimensionally, when viewed by a user registered in the electronic device 101 of the disclosure according to various embodiments.

An application being executed in FIG. 13 may be an image viewer or gallery. The fifth execution screen 1310 may include personal information such as a first photo 1311. The first photo 1311 may be, for example, a photo related to a one-time password.

In an embodiment, the electronic device 101 may, under the control of the processor 120, identify whether the fifth execution screen 1310 of the image viewer or gallery, which is an application being executed, includes personal information requiring security.

In an embodiment, when the fifth execution screen 1310 includes personal information such as the first photo 1311, the electronic device 101 may, under the control of the processor 120, generate disparity information and/or pattern information, based on a property of the personal information. The personal information included in the fifth execution screen 1310 may be an image.

Referring to a screen 1301, the electronic device 101 may, under the control of the processor 120, display, based on the disparity information and as the fifth execution screen 1310, a first video (or first image) displayed to the left eye and a second video (or second image) displayed to the right eye separately on the display 260 and simultaneously display a stripe pattern 1312.

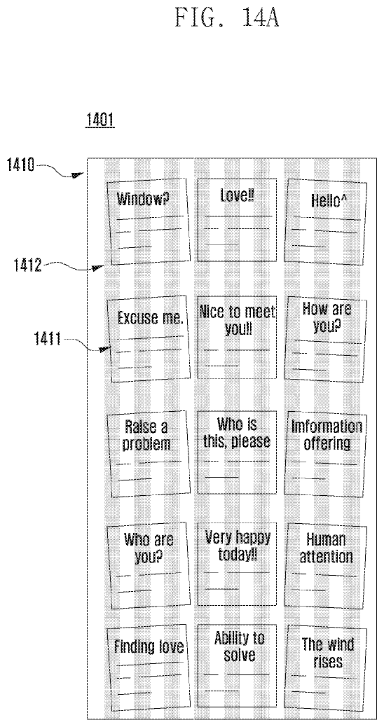

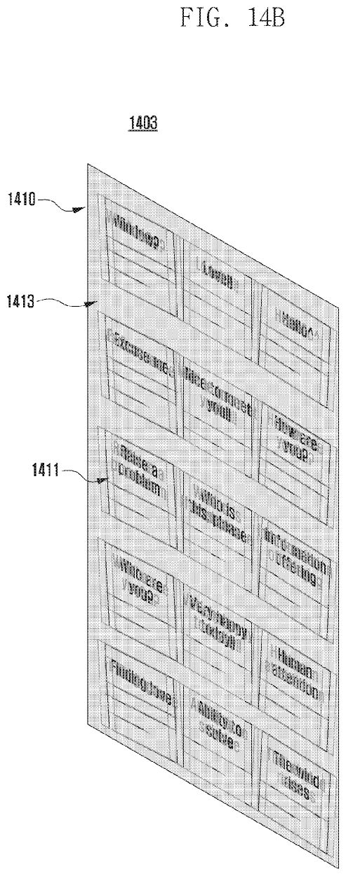

FIG. 14A is a diagram illustrating a sixth execution screen 1410 displayed three-dimensionally, when viewed by a user registered in the electronic device 101 of the disclosure according to various embodiments.

FIG. 14B is a perspective view illustrating a sixth execution screen 1410 that is displayed three-dimensionally, when viewed by a user registered in the electronic device 101 of the disclosure according to various embodiments.

In FIG. 14A, an application being executed may be an image viewer or gallery. The sixth execution screen 1410 may include personal information such as a second photo 1411. The second photo 1411 may be, for example, a photo including text such as a memo.

In an embodiment, the electronic device 101 may, under the control of the processor 120, identify whether the sixth execution screen 1410 of the image viewer or gallery, which is an application being executed, includes personal information requiring security.

In an embodiment, when the sixth execution screen 1410 includes personal information such as the second photo 1411, the electronic device 101 may, under the control of the processor 120, generate disparity information and/or pattern information, based on a property of the personal information. The personal information included in the sixth execution screen 1410 may be an image.

Referring to a screen 1401, the electronic device 101 may, under the control of the processor 120, display, based on the disparity information and as the sixth execution screen 1410, a first video (or first image) displayed to the left eye and a second video (or second image) displayed to the right eye separately on the display 260 and simultaneously display a stripe pattern 1412.

In an embodiment, when the sixth execution screen 1410 includes personal information such as the second photo 1411, the electronic device 101 may, under the control of the processor 120, generate disparity information and/or contrast information, based on a property of the personal information. The personal information included in the sixth execution screen 1410 may be an image.

Referring to a screen 1403, the electronic device 101 may, under the control of the processor 120, display, based on the disparity information and as the sixth execution screen 1410, a first video (or first image) displayed to the left eye and a second video (or second image) displayed to the right eye separately on the display 260 and simultaneously display a contrast effect 1413.

In an example embodiment, an electronic device 101 may include a display 260 configured to display a three-dimensional screen, a camera (e.g., the first camera 281 or the eye tracking sensor 282), a memory 130 configured to store instructions, and at least one processor 120, wherein the instructions, when executed by the at least one processor 120, cause the electronic device 101 to identify whether a first screen corresponding to an application being executed on the display 260 and having a two-dimensional image includes personal information requiring security, in case that the personal information is included, generate disparity information, based on a property of the personal information, and control the display 260 to display at least a part of the first screen as a second screen having parallax between the left eye and the right eye, based on the disparity information.

In an example embodiment, the second screen may be displayed to correspond to a gaze of a subject whose line of sight is tracked by the camera (e.g., the first camera 281 or the eye tracking sensor 282).

In an example embodiment, the instructions, when executed by the at least one processor 120, may cause the electronic device 101 to control the display 260 to display all of the first screen as the second screen having parallax between the left eye and the right eye.

In an example embodiment, the instructions, when executed by the at least one processor 120, may cause the electronic device 101 to control the display 260 to display an area of the first screen corresponding to the first information as the second screen having parallax between the left eye and the right eye.

In an example embodiment, the instructions, when executed by the at least one processor 120, may cause the electronic device 101 to, in case that the personal information is included, generate at least one of pattern information or contrast information, and control the display 260 to display the second screen, based on at least one of the disparity information, the pattern information, or the contrast information.

In an embodiment, the instructions, when executed by the at least one processor 120, may cause the electronic device 101 to register a user captured using the camera (e.g., the first camera 281 or the eye tracking sensor 282), and in case that through the camera (e.g., the first camera 281 or the eye tracking sensor 282), detection of the user fails, a unregistered user is detected, or multiple users are detected, control the display 260 to display the second screen.

In an example embodiment, the instructions, when executed by the at least one processor 120, may cause the electronic device 101 to, in case that a secure mode is configured, identify whether the first screen includes the personal information requiring security.

In an example embodiment, the secure mode is configured through at least one of a setting application or a control panel.

In an example embodiment, the property of the personal information may include at least one of a size, a spacing, and a font of text in case that the personal information includes the text.

In an example embodiment, the property of the personal information may include at least one of pieces of information on a size, a shape, or a color of an object included in an image in case that the personal information includes the image.

In an example embodiment, the instructions, when executed by the at least one processor 120, may cause the electronic device 101 to identify disparity information corresponding to a property of personal information stored in the memory 130, and perform control to display the second screen, based on the identified disparity information.

In an example embodiment, a screen display method of an electronic device 101 may include identifying whether a first screen corresponding to an application being executed on a display 260 configured to display a three-dimensional screen and having a two-dimensional image includes personal information requiring security, in case that the personal information is included, generating disparity information, based on a property of the personal information, and controlling the display 260 to display at least a part of the first screen as a second screen having parallax between the left eye and the right eye, based on the disparity information.

In an example embodiment, the screen display method of the electronic device 101 may include controlling the display 260 to display all of the first screen as the second screen having parallax between the left eye and the right.

In an example embodiment, the screen display method of the electronic device 101 may include controlling the display 260 to display an area of the first screen corresponding to the first information as the second screen having parallax between the left eye and the right eye.

In an example embodiment, the screen display method of the electronic device 101 may include, in case that the personal information is included, generating at least one of pattern information or contrast information, and controlling the display 260 to display the second screen, based on at least one of the disparity information, the pattern information, or the contrast information.

In an example embodiment, the screen display method of the electronic device 101 may include registering a user captured using a camera (e.g., the first camera 281 or the eye tracking sensor 282), and in case that through the camera (e.g., the first camera 281 or the eye tracking sensor 282), detection of the user fails, a unregistered user is detected, or multiple users are detected, controlling the display 260 to display the second screen.

In an example embodiment, the screen display method of the electronic device 101 may include, in case that a secure mode is configured, identifying whether the first screen includes the personal information requiring security.

In an example embodiment, the screen display method of the electronic device 101 may include identifying disparity information corresponding to a property of personal information stored in a memory 130, and performing control to display the second screen, based on the identified disparity information.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that the various embodiments and the terms used therein are not intended to limit the technological features set forth herein to particular embodiments and the disclosure includes various changes, equivalents, and/or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a purchaser. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a display configured to display a three-dimensional screen;
a camera;
memory for storing instructions; and
at least one processor, comprising processing circuitry,
wherein the instructions, when executed by the at least one processor, cause the electronic device to:
identify whether a first screen corresponding to an application being executed on the display and having a two-dimensional image, includes personal information requiring security;
based on the personal information being included, generate disparity information, based on properties of the personal information; and
control the display to display at least a part of the first screen as a second screen having parallax between the left eye and the right eye, based on the disparity information.

2. The electronic device of claim 1, wherein the second screen is displayed to correspond to a gaze of a subject, wherein the camera is configured to track the gaze.

3. The electronic device of claim 1, wherein the instructions, when executed by the at least one processor, cause the electronic device to control the display to display all of the first screen as the second screen having parallax between the left eye and the right eye.

4. The electronic device of claim 1, wherein the instructions, when executed by the at least one processor, cause the electronic device to control the display to display an area of the first screen, corresponding to the first information, as the second screen having parallax between the left eye and the right eye.

5. The electronic device of claim 1, wherein the instructions, when executed by the at least one processor, cause the electronic device to:
based on the personal information being included, generate at least one of pattern information and/or contrast information; and
control the display to display the second screen, based on at least one of the disparity information, the pattern information, and/or the contrast information.

6. The electronic device of claim 1, wherein the instructions, when executed by the at least one processor, cause the electronic device to:
register a user captured using the camera; and
based on, through the camera, detection of the user failing, a unregistered user is detected, and/or multiple users are detected, control the display to display the second screen.

7. The electronic device of claim 1, wherein the instructions, when executed by the at least one processor, cause the electronic device to, based on a secure mode being configured, identify whether the first screen includes the personal information requiring security,
wherein the secure mode is configured to be entered through at least one of a setting application or a control panel, and
wherein the properties of the personal information comprise:
at least one of a size, a spacing, and a font of text based on the personal information including the text; and
at least one of information on a size, a shape, or a color of an object included in an image based on the personal information including the image.

8. The electronic device of claim 1, wherein the instructions, when executed by the at least one processor, cause the electronic device to:
identify disparity information corresponding to properties of personal information stored in the memory; and
display the second screen, based on the identified disparity information.

9. A screen display method of an electronic device, the method comprising:
identifying whether a first screen, corresponding to an application being executed on a display configured to display a three-dimensional screen and having a two-dimensional image, includes personal information requiring security;
based on the personal information being included, generating disparity information, based on properties of the personal information; and
displaying at least a part of the first screen as a second screen having parallax between the left eye and the right eye, based on the disparity information.

10. The method of claim 9, wherein the second screen is displayed to correspond to a gaze of a subject the eyes tracked by a camera.

11. The method of claim 9, comprising displaying all of the first screen as the second screen having parallax between the left eye and the right eye.

12. The method of claim 9, comprising displaying an area of the first screen, corresponding to the first information, as the second screen having parallax between the left eye and the right eye.

13. The method of claim 9, comprising:
based on the personal information being included, generating at least one of pattern information or contrast information; and
displaying the second screen, based on at least one of the disparity information, the pattern information, and/or the contrast information.

14. The method of claim 9, comprising:
registering a user captured using the camera; and
based on, through the camera, detection of the user failing, an unregistered user is detected, and/or multiple users are detected, displaying the second screen.

15. The method of claim 9, comprising, based on a secure mode being configured, identifying whether the first screen includes the personal information requiring security,
wherein the secure mode is configured through at least one of a setting application or a control panel, and
wherein the properties of the personal information comprise:
at least one of a size, a spacing, and a font of text based on the personal information including the text; and
at least one of information on a size, a shape, and/or a color of an object included in an image based on the personal information including the image.

16. A computer-readable storage medium storing a computer program including instructions for executing a screen display method of an electronic device,
wherein the instructions, when executed individually or collectively by one or more processors, cause the electronic device to:
identify whether a first screen corresponding to an application being executed on the display and having a two-dimensional image, includes personal information requiring security;
based on the personal information being included, generate disparity information, based on properties of the personal information; and
control the display to display at least a part of the first screen as a second screen having parallax between the left eye and the right eye, based on the disparity information.

17. The computer-readable storage medium of claim 16, wherein the second screen is displayed to correspond to a gaze of a subject, wherein the camera is configured to track the gaze.

18. The computer-readable storage medium of claim 16, wherein the instructions, when executed individually or collectively by the one or more processors, cause the electronic device to:
control the display to display all of the first screen as the second screen having parallax between the left eye and the right eye.

19. The computer-readable storage medium of claim 16, wherein the instructions, when executed individually or collectively by the one or more processors, cause the electronic device to:
control the display to display an area of the first screen, corresponding to the first information, as the second screen having parallax between the left eye and the right eye.

20. The computer-readable storage medium of claim 16, wherein the instructions, when executed individually or collectively by the one or more processors, cause the electronic device to:
based on the personal information being included, generate at least one of pattern information and/or contrast information; and
control the display to display the second screen, based on at least one of the disparity information, the pattern information, and/or the contrast information.
